(19) United States
(12) Patent Application Publication
(10) Pub. No.: US 2022/0404167 A1
(43) Pub. Date: Dec. 22, 2022

(54) ROADWAY OCCLUSION DETECTION AND REASONING

(71) Applicant: GM GLOBAL TECHNOLOGY OPERATIONS LLC, Detroit, MI (US)

(72) Inventors: Rajesh Ayyalasomayajula, Austin, TX (US); Orhan Bulan, Novi, MI (US)

(73) Assignee: GM GLOBAL TECHNOLOGY OPERATIONS LLC, Detroit, MI (US)

(21) Appl. No.: 17/304,469

(22) Filed: Jun. 22, 2021

(51) Int. Cl. G01C 21/00; G06T 7/70; G06F 40/169; G06K 9/00

(52) U.S. Cl. CPC G01C 21/3815; G06T 7/70; G06F 40/169; G06K 9/00651; G06T 2207/10032

(57) ABSTRACT

A method for updating a map including receiving a first image depicting a geographical area including a first roadway and an occluded area, determining a location of the first roadway segment in response to the first image, receiving a plurality of vehicle telemetry data associated with the first roadway segment and a second roadway segment within the occluded area, updating a map data with the location of the first roadway, determining a location of the occluded area in response to the first image and the plurality of vehicle telemetry data associated with the second roadway segment, requesting an alternate data in response to determination of the location of the occluded area, determining a location of a second roadway segment in response to the alternate data wherein the second roadway segment was occluded in the first image, and updating the map data with the location of the second roadway segment.

### BACKGROUND

The present disclosure relates generally to electronic map generation systems. More specifically, aspects of this disclosure relate to systems, methods, and devices for roadway map generation by detecting roadway segments from aerial imagery, detecting occluded roadway segments from aerial imagery, and receiving information to map the occluded roadway segments via other mapping mechanisms.

In recent years, driver assistance technology in vehicles has made tremendous advances, including occupant safety, autonomous operation, obstacle detection, information and entertainment systems and the like. As the operation of modern vehicles is becoming more automated these vehicles are able to provide autonomous driving control with less and less driver intervention. Vehicle automation has been categorized into numerical levels ranging from zero, corresponding to no automation with full human control, to five, corresponding to full automation with no human control. Various automated driver-assistance systems (ADAS), such as cruise control, adaptive cruise control, and parking assistance systems correspond to lower automation levels, while true “driverless” vehicles correspond to higher automation levels. In order to perform these automated driving operations, the vehicle control systems rely on accurate maps to establish lane locations, obstacle locations, roadway intersections, and the like.

Typically, maps used by ADAS equipped vehicles are generated using ground-surveying methods, such as mapping vehicles travelling each roadway and precisely determining the physical locations or roadway features. Extracting road features from top-down imagery has recently been adopted to create medium definition (MD) and high definition (HD) maps at scale for autonomous vehicles. While this methodology overcomes the inherent scaling challenges of ground—surveying based MD/HD map creation process, it suffers from the fact that some of the road surfaces are not visible in the top-down imagery due to oblique angle, tree occlusions, stacked roads, or high buildings. It would be desirable to overcome these problems to provide a map generation system using aerial photography with roadway occlusion detection and reasoning.

The above information disclosed in this background section is only for enhancement of understanding of the background of the invention and therefore it may contain information that does not form the prior art that is already known in this country to a person of ordinary skill in the art.

### SUMMARY

Disclosed herein are various electronic systems and related control logic for provisioning electronic map generation systems, methods for making and methods for operating such systems. By way of example, and not limitation, there is presented a computing system which may be provided to generate maps for use by ADAS equipped vehicles by performing image processing techniques on aerial imagery to detect roadway and other occlusions and methods for reasoning such occlusions.

In accordance with an aspect of the present disclosure, a method including receiving a first image depicting a geographical area including a first roadway and an occluded area, determining a location of the first roadway segment in response to the first image, receiving a plurality of vehicle telemetry data associated with the first roadway segment and a second roadway segment within the occluded area, updating a map data with the location of the first roadway, determining a location of the occluded area in response to the first image and the plurality of vehicle telemetry data associated with the second roadway segment, requesting an alternate data in response to determination of the location of the occluded area, determining a location of a second roadway segment in response to the alternate data wherein the second roadway segment was occluded in the first image, and updating the map data with the location of the second roadway segment.

In accordance with another aspect of the present disclosure, wherein the first image is an aerial image depicting a top down view of the geographical area.

In accordance with another aspect of the present disclosure, wherein the second roadway is a continuation of the first roadway.

In accordance with another aspect of the present disclosure, wherein the alternate data is captured by a mapping vehicle travelling within the occluded area.

In accordance with another aspect of the present disclosure, wherein the alternate data is a second image captured at a different time than the first image.

In accordance with another aspect of the present disclosure, wherein the alternate data includes a plurality of vehicle locations and directions of travel.

In accordance with another aspect of the present disclosure, wherein the location of the first roadway is determined using image processing techniques on the first image.

In accordance with another aspect of the present disclosure, wherein the location of the first roadway is determined in response to the first image and a principal component analysis of vehicle locations and directions of travel associated with the geographical area.

In accordance with another aspect of the present disclosure further operative for annotating the map data with a location of the occluded area in response to determining the location of the occluded area in response to the first image.

In accordance with another aspect of the present disclosure, an apparatus for updating a map data including a network interface to receive a first image and an alternate data, the network interface further configured to transmit a request, a memory configured to store the map data, and a processor configured to determine a location of a first roadway in response to the first image wherein the first image depicts a geographical area including the first roadway and an occluded area, update the map data with the location of the first roadway, determine a location of the occluded area in response to the first image, generate the request and couple the request to the network interface wherein the request includes a command for an alternate data in response to determination of the location of the occluded area, determine a location of a second roadway in response to the alternate data wherein the second roadway was occluded in the first image and update the map data with the location of the second roadway.

In accordance with another aspect of the present disclosure, wherein the first image is an aerial image depicting a top down view of the geographical area.

In accordance with another aspect of the present disclosure, wherein the network interface is wireless network interface coupled to a cellular data network.

In accordance with another aspect of the present disclosure, wherein the alternate data is captured by a mapping vehicle travelling within the occluded area.

In accordance with another aspect of the present disclosure, wherein the alternate data is a second image captured at a different time than the first image.

In accordance with another aspect of the present disclosure, wherein the alternate data includes a plurality of vehicle locations and directions of travel.

In accordance with another aspect of the present disclosure, wherein the location of the first roadway is determined using image processing techniques on the first image.

In accordance with another aspect of the present disclosure, wherein the location of the first roadway is determined in response to the first image and a principal component analysis of vehicle locations and directions of travel associated with the geographical area.

In accordance with another aspect of the present disclosure, wherein the processor is further configured to annotate the map data with the location of the occluded area in response to determining the location of the occluded area in response to the first image.

In accordance with another aspect of the present disclosure, an apparatus including a memory configured to store a map data, a processor configured to receive a first image, determine a location of a first roadway in response to the first image, update the map data in response to the location of the first roadway, determine a location of an occluded area in response to the first image, request an alternate data in response to determination of the location of the occluded area, determine a location of a second roadway in response to the alternate data wherein the second roadway is occluded in the first image, and update the map data with the location of the second roadway, and a network interface for receiving the first image the alternate data and for transmitting the request for alternate data via a data network.

In accordance with another aspect of the present disclosure, wherein the alternate data is a second image depicting the geographical area including the first roadway and the occluded area wherein the second image is captured from a different orientation than the first image.

The above advantage and other advantages and features of the present disclosure will be apparent from the following detailed description of the preferred embodiments when taken in connection with the accompanying drawings.

### BRIEF DESCRIPTION OF THE DRAWINGS

The above-mentioned and other features and advantages of this invention, and the manner of attaining them, will become more apparent and the invention will be better understood by reference to the following description of embodiments taken in conjunction with the accompanying drawings.

FIG. 1 shows an exemplary application for map generation employing roadway occlusion detection and reasoning according to an exemplary embodiment.

FIG. 2 shows a block diagram of a system for map generation employing roadway occlusion detection and reasoning according to an exemplary embodiment.

FIG. 3 shows a flowchart illustrating a method for map generation employing roadway occlusion detection and reasoning according to an exemplary embodiment.

FIG. 4 shows a block diagram illustrating another system for map generation employing roadway occlusion detection and reasoning according to an exemplary embodiment.

FIG. 5 shows a flowchart illustrating another method for map generation employing roadway occlusion detection and reasoning according to an exemplary embodiment.

FIG. 6 shows a flowchart illustrating another method for map generation employing roadway occlusion detection and reasoning according to an exemplary embodiment

FIG. 7 shows a flowchart illustrating another method for map generation employing roadway occlusion detection and reasoning according to an exemplary embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

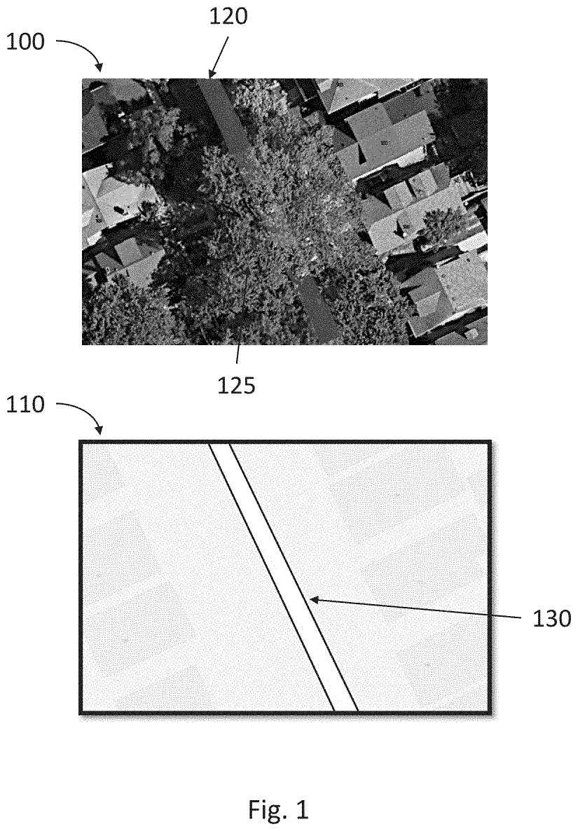

Turning now to FIG. 1, an exemplary application for map generation employing roadway occlusion detection and reasoning according to an exemplary embodiment is shown. An exemplary aerial image 100 is shown illustrating a top-down view including of an exemplary roadway 120 with occlusions 125. An aerial image 110 of the same exemplary roadway is also shown illustrating the same top down view with the exemplary roadway 130 depicted. As can be seen in the aerial image 110, the view of parts of the roadway 120 are obfuscated from view. A traditional top-view mapping system may not be able to map the roadway in light of this obscured view. Occlusions in a top-view image may include trees, tall buildings, shadows, overpasses, and stacked roadways such as on bridges.

The exemplary map generation system employs a methodology that receives aerial images of geographical locations from satellite or aerial image providers. The method first detects unobscured road segments using aerialimagery, crowd sourced vehicle telemetry and/or existing map data. The system is next configured to detect and map the obscured regions using other means, such as sending a mapping vehicle to those regions or using crowdsourcing activities to augment the map of unobscured road segments created from the top-down imagery. In the case of tree occlusions or shadows specifically, these roadway segments may be identified such that additional aerialimagery may be captured at a different time of the year or day for these roadway segments. Multi-layer roadways may be mapped using crowdsourced vehicle location and velocity data to determine a direction of traffic flow of the different layer roadways and to correlate these with the unobstructed roadway segments.

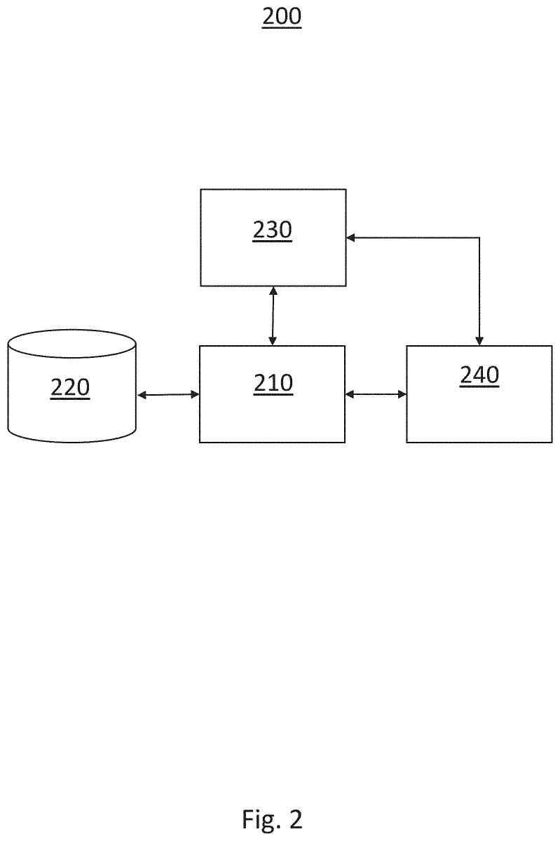

Turning now to FIG. 2, a system 200 for map generation employing roadway occlusion detection and reasoning according to an exemplary embodiment is shown. The exemplary system 200 includes a processor 210, an aerial imagery source 230, a memory 220 and a network interface 240. In one or more exemplary embodiments, the aerial imagery source 230 is configured to receive aerial imagery of geographical locations which depict roadway surfaces. For example, the aerial images may be top down images, such as the one shown in FIG. 1, and captured by an aerialdrone of a highway interchange or may be satellite imagery captured by orbiting satellites. Each image may include location information, such as global positioning system (GPS) metadata, altitude, latitude, and longitude information, and/or other metadata such that the roadway location may be correlated with additional map data and other aerial imagery.

The aerial imagery source 230 may include an imagery network interface for receiving the aerial images from a remote source, such as a server, imagery server, or other connected source or vendor of aerial imagery images. The imagery network interface may be separate from the network interface 240. Alternatively, the aerial imagery source may be coupled to the network interface 240 for receiving the aerial imagery via a wireless network, such as a cellular data network or wireless local area network, or may be a wired network, such as a local area network, universal serial bus (USB) connection or the like. The aerial imagery source 230 may further include an aerial imagery memory for storing the received aerial images and coupling the aerial images to the processor 210 in response to a request from the processor 210.

The aerial imagery source 230 may provide aerial or top-view images of geographical location including roadways, parking lots, private roads, laneways, and other vehicle traversable surfaces, and provide these images to the processor 210 for feature extraction and/or multi-dimensional clustering. The processor 210 is operative for detecting obscured roadway segments, such as tree occlusion or stacked roads, where a MD map creation process may not detect road features reliably. The processor 210 identifies inaccurately mapped or unmapped roadway segments using aerialimagery and crowd sourced vehicle telemetry. The processor 210 may detect occluded roadway segments, such as due to tree occlusion or shadows, by classifying a sequence of images and fusing the classification probabilities. Stacked roads may be detected in two stages by first using vehicle telemetry and then pruning the crowdsourced vehicle telemetry by processing aerialimages.

The processor 210 is configured to receive the aerial images from the aerial imagery source 230 and to process the received aerial images to determine occurrences and locations of depicted roadways. The processor 210 may be an image processor or the like and may be configured to perform feature extraction from the aerial images. For example, the processor 210 may perform image processing techniques, such as edge detection, to detect roadway surfaces within in the images. The processor 210 may then correlate the location of the surfaces detected in the aerial image to map data stored in the memory 220. The processor 210 may then update the map data stored in the memory 220 to include detected roadway surfaces from the received aerial image.

In addition, the processor 210 may determine that an occlusion of a roadway is present in the aerial image. The occlusion may be detected in response to a discontinuity of a detected roadway within an image, color change within the aerial image indicative of shadows, detection of buildings obfuscating a roadway or the like. In response to the detection of an occlusion, the processor 210 may note the occlusion with the map data and store the annotated map data within the memory 220. In addition, the processor 210 may generate a request indicative of the occlusion via the network interface 240 to request data to resolve the occlusion.

In response to detection of an occlusion, the processor 210 is configured for mapping these roadway segments using other means. In some embodiments, the occluded roadway detection may be performed by an alternate methods, such as by a mapping vehicle or crowdsourcing activities, to detect locations of the occluded roadway. Alternatively, a request may be made for an aerial image of the same location taken from a different angle, at a different time of day or different time of year. This alternate aerial image may provide a clearer view of the roadway. In response to the request by the processor 210 via the network interface 240, the network interface 240 may receive the alternate image or alternate roadway data. The processor 210 is then configured to update the map data in response to the alternate data to resolve the roadway occlusion. The alternate data may include an alternate view of the occluded roadway which may be processed similarly to the prior top-down image. The alternate data may be data mapped by a vehicle. This data may be integrated into the stored mapped data to resolve the occluded roadway areas with the previously mapped roadways used as location references points.

In some embodiments, the roadway occlusion may result from multilayer roadways, such as overpasses and stacked highways. The processor 210 may then be configured to detect cluster formations determined from data received from vehicles travelling the roadway indicative of location and direction travelled. Feature extraction using the cluster information and the aerial image may be performed by employing Principal Component Analysis (PCA). PCA is used to reduce the number of variables of the data set in order to simplify the data analysis. Multi-dimensional clustering may be performed by performing unsupervised learning to find clusters, or denser regions, of the cluster set. For example, Hierarchical Density-Based Spatial Clustering (HBDSCAN)® may be used.

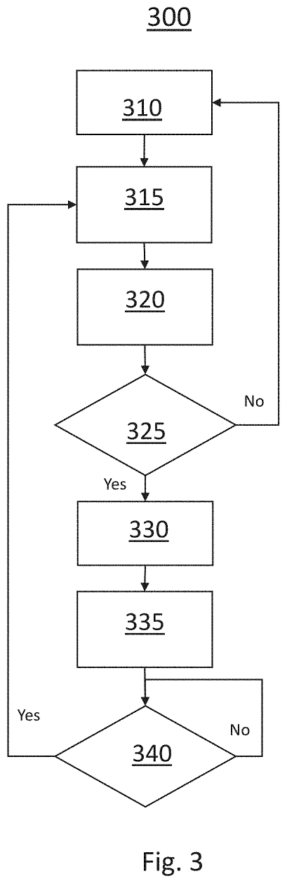

Turning now to FIG. 3, a flowchart illustrating a method 300 for map generation employing roadway occlusion detection and reasoning according to an exemplary embodiment is shown. The exemplary method 300 may first receive 310 an aerial image for map generation. The aerial image may be received via a network interface or other data interface for receiving electronic data. The aerial image may be a top-down view image of a geographical location including roadways, other driving surfaces, and driving obstacles.

In response to receiving the aerial image, the method 300 next detects 315 roadways within the aerial image. Roadways may be detected within the aerial image using image processing techniques, such as edge detection, color detection, etc., or may be detected in conjunction with vehicle data, such as vehicle location and velocity data, etc.

In response to detecting roadways, the method 300 augments 320 or updates a map stored in a memory. In addition, the detected roadway data may be uploaded to a data server or distributed to client devices, such as autonomous vehicles, ADAS vehicle controller, or the like. In one or more exemplary embodiments, the map data is augmented to include the newly detected drivable roadways. The augmented data may include roadway locations and dimensions, vehicle flow directions, lane information and the like.

The method 300 next estimates 325 if there are any roadway occlusions in the aerial image. These roadway occlusions may be estimated in response to discontinuities in detected roadways, changes in color at a junction between a detected roadway and a possible occlusion, inconsistent vehicle data related to the aerial image, such as vehicles travelling through the occluded area. Occluded areas may further be detected by image processing techniques on the aerial image or in response to inconsistencies with stored map data or the like.

If no occlusion is detected, the method 300 returns to receive 310 a subsequent aerial image. If an occlusion is detected, the method 300 transmits 330 a request for additional information about the occlusion. This request may include request for data and/or images from vehicles travelling the occluded area, requesting that a mapping vehicle be sent to the occluded area, or requesting additional aerial images from different times of day, different times of the year, or aerial images taken from different angles to the occluded area. The method 300 may next annotate 335 the map data stored in memory or metadata associated with the map data to indicate the location of the possible occluded area.

In response to the request for additional data concerning the occluded area, the method 300 is next configured to receive 340 the alternate data. The method 300 then returns to detecting 315 roadways within the alternate data. In response to detected roadways within the alternate data, the method 300 then augments 320 the map data with the detected roadways. The method 300 may or may not remove the annotation of the occluded area in response to the detected roadway. This remaining annotation may be indicative of a lower certainty of detection which may be reduced with additional data or later detections from aerial photographs taken at different times of day or different times of the year.

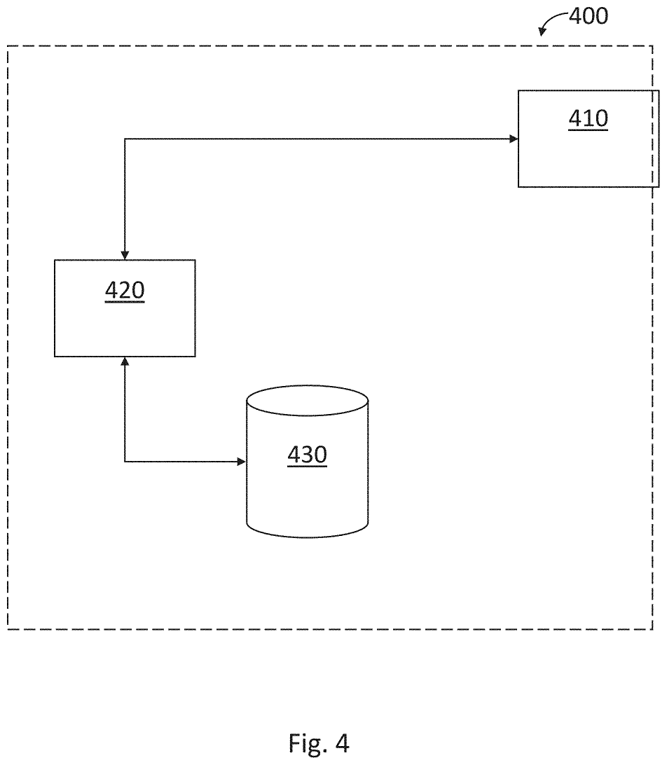

Turning now to FIG. 4, a diagram illustrating an exemplary embodiment of an apparatus 400 for map generation employing roadway occlusion detection and reasoning is shown. The exemplary apparatus may include a network interface 410, a processor 420, and a memory 430.

In one or more exemplary embodiments, the network interface 410 may include a wireless network interface or connecting to a wireless network such as a cellular network or a Wi-Fi network. Alternatively, the network interface 410 may be a wired network interface for coupling to a wired network such as a local area network for coupling data to and from a server or other data or image source via the Internet. The network interface 410 may be configured to receive images from a data source, such as an aerial drone or satellite, or a server or service provider for providing such images. The images may depict geographical location from a top-down perspective or bird's eye perspective. The images may depict roadways within the geographical location. In some exemplary embodiments, images may also depict regions or areas that are occluded from view. These occlusions may result from trees, buildings, overpasses, tunnels, and the like.

The network interface 410 may further be configured for transmitting and receiving data and for transmitting data requests. The data request may be generated in response to detecting an occlusion within an aerial image for requesting additional data related to the area occluded from view in the aerialimage. This additional data may be generated by a mapping vehicle, images taken at earlier time or date of the same geographical location, vehicle location and velocity data, and the like.

The exemplary system may further include a memory 430 configured to store map data. This memory 430 may be electrically coupled to the processor 420 for transmitting and receiving data between the processor 420 and the memory 430. The memory 430 may be a hard drive, solid state memory device, network data storage location, or other electronic storage media. The map data stored in the memory 430 maybe coupled to ADAS equipped vehicles for use with a vehicle control system.

The processor 420 may be configured to determine a location of a first roadway in response to a first image received via the network interface 410. In some exemplary embodiments, the first image may be an aerial image showing a geographical area including a first roadway and an occluded area. The processor 420 may detect the first roadway within the first image, determine a location of the first roadway, and update the map data with the location of the first roadway. In addition, the processor 420 may determine a location of an occluded area within the first image. The processor 420 may annotated the map data to include information related to the occluded area. The map data may be updated in the future in response to the annotation. In some instances, information may be assumed with some probability in response to the annotation, such as the continuation or a roadway.

In some embodiments, the processor 420 may generate a request for additional data related to the occluded area and couple this request via the network interface 410 to a data provider. The request may include a request for an alternate data to reason or resolve the occluded area in response to the determination of the location of the occluded area. The additional data may include additional photographs of the occluded area take during different seasons, time of day, time of year or the like. The additional data may include mapping data captured by mapping vehicles traveling with the occluded area. The additional data may include vehicle location, velocity, direction, or other telemetry data crowdsourced from multiple vehicles travelling in the occluded area.

In response to receiving the alternate data in response to the transmitted request, the processor 420 may then determine a location of a second roadway in response to the alternate data wherein the second roadway was occluded in the first image. The processor 420 may then update the map data within the memory with the location and/or dimensions and other data associated with the second roadway.

In one or more exemplary embodiments, the map generation apparatus may be a data server including a memory 430 configured to store a map data. The server may further be configured for receiving requests for map data and transmitting the map data in response to the requests via a network interface 410. The server may also receive data used to update the map data, such as aerial photography of geographic locations, vehicle location and velocity data, roadway data from mapping vehicles and the like.

In some exemplary embodiments, the processor 420 may be configured to receive a first image, such as an aerial image, and determine a location of a first roadway in response to the first image. The first image may an aerial image received from an aircraft, a drone or a satellite depicting a top down view of the geographical area. The location of the first roadway may be determined using image processing techniques on the first image. The location of the first roadway may be determined in response to the first image and a principal component analysis of vehicle locations and directions of travel associated with the geographical area. The processor 420 may be further configured to update the map data stored in the memory 430 in response to the location of the first roadway.

The processor 420 may be configured to determine a location of an occluded area in response to the first image. The occluded area may be determined in response to image processing techniques, color changes, edge detection, discontinuities with detected roadways, vehicle location and velocity data, and discrepancies between the first image and other stored data, such as map data or the like. The processor may be configured to annotate the map data with the location of the occluded area in response to determining the location of the occluded area in response to the first image. This annotation of the map data may be used as a future indicator for a need to reason the occluded area with additional data.

The processor may generate a request for an alternate data in response to determination of the location of the occluded area. In some embodiments, the alternate data may be a second image depicting the geographical area including the first roadway and the occluded area wherein the second image is captured from a different orientation than the first image. In some instances, the alternate data may be a second image captured at a different time than the first image. In addition, the alternate data may be captured by a mapping vehicle travelling within the occluded area.

The processor 420 may then determine a location of a second roadway in response to the alternate data wherein the second roadway is occluded in the first image and update the map data with the location of the second roadway. The updated map data may then be transmitted to vehicle control systems or the like for use in ADAS equipped vehicles. In some exemplary embodiments, the network interface 410 is configured for receiving the first image the alternate data and for transmitting the request for alternate data via a data network. The network interface 410 may be a wireless network interface coupled to a cellular data network.

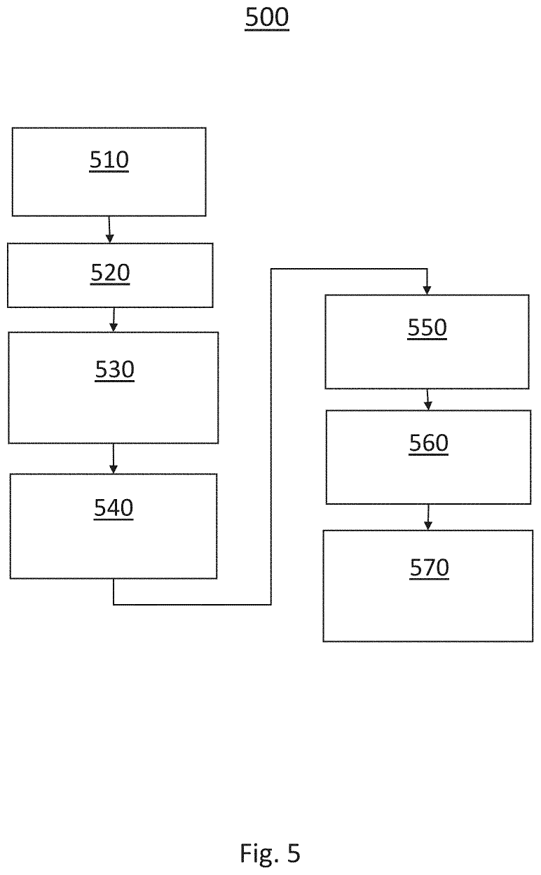

Turning now to FIG. 5, a flowchart illustrating an exemplary implementation of a method 500 for intelligent wireless protocol optimization is shown. This exemplary method 500 may be configured to receive aerial imagery including a top down view of geographical locations in order to identify roadways and other obstacles in order to generate accurate map data for use by ADAS equipped vehicles. In some instances, the aerial imagery may have occluded areas which need to be reasoned through the user of additional data.

The method 500 is first configured for receiving 510 a first image depicting a geographical area including a first roadway and an occluded area. In some instances, the first image is an aerial image depicting a top down view of the geographical area. The image may be captured by an aircraft, an aerial drone, a satellite, or other means for capturing a top down perspective view of a geographical location.

The method 500 next determines 520 a location of the first roadway in response to the first image. The location of the first roadway may be determined using image processing techniques on the first image. In addition, he location of the first roadway may be determined in response to the first image and a principal component analysis of vehicle locations and directions of travel associated with the geographical area. For example, multiple vehicles travelling through an occluded area may provide a good indication of the presence of a roadway, the direction of travel of the roadway, number of vehicle lanes and other information related to the roadway.

The method 500 next updates 530 the map data with the location of the first roadway. Updating the map data may including adding the roadway to the map data, updating a location or dimensions of the roadway within the map data, updating information regarding the roadway, such as direction of travel, physical dimensions, number of lanes or the like. In addition, updating the map data may including adding metadata for annotating a new addition or update to the map data, which may then be confirmed by additional data or a human confirmation.

The method 500 next determines 540 a location of the occluded area in response to the first image. The occluded area may be determined via image processing techniques, such as edge detection, color changes, discontinuities in roadways, crowdsourced vehicle location and velocity data, and correlation with other roadway and map data. The method 500 may be further operative for annotating the map data with a location of the occluded area in response to determining the location of the occluded area in response to the first image. This annotation may be used as an indication of a need to request addition information related to the occluded area and resolve the occlusion or may be used as an indicator of a calculated level of confidence of a roadway existing or not existing.

The method 500 is next configured for requesting 550 an alternate data in response to determination of the location of the occluded area. In some exemplary embodiments, the request may be made that a mapping vehicle may be dispatched to the occluded area to gather the alternate data. In this example, the alternate data may be captured by a mapping vehicle travelling within the occluded area. Alternatively, the alternate data is a second image captured by an aerial drone, aircraft, or satellite at a different time than the first image. The different timing may resolve issues within shadows where the different time is a different time of day or foliage where the different timing is a different season. Thus, images captured in winter, for example, may allow detection of the roadway when trees lack foliage. In another example, the alternate data includes a plurality of vehicle locations and directions of travel. This crowdsourced data may be used to determine the direction of travel, number of lanes, presence of a roadway, underpasses and overpasses and other information.

A location of a second roadway is next determined 560 in response to the alternate data wherein the second roadway was occluded in the first image. In some embodiments, the second roadway may be a continuation of the first roadway. The method 500 is next configured for updating 570 the map data with the location of the second roadway.

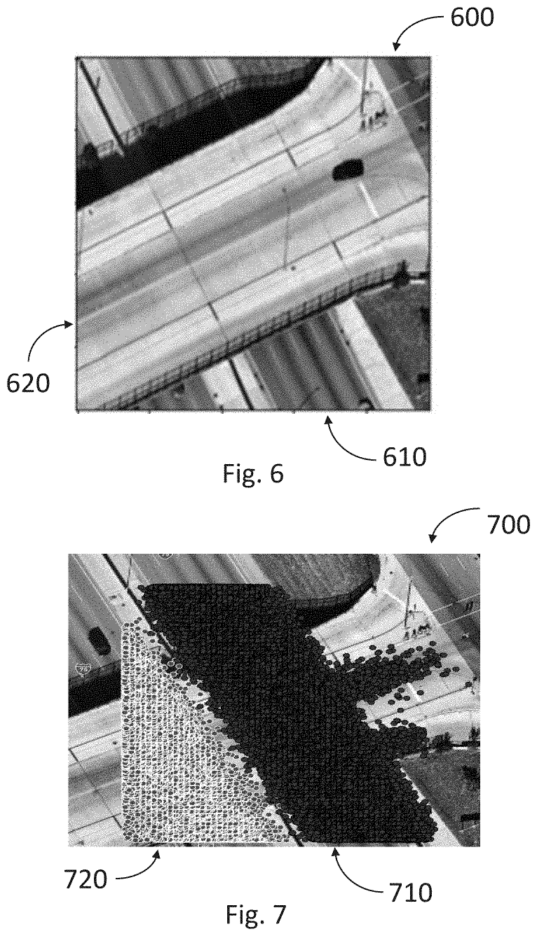

Turning now to FIG. 6, an exemplary aerial image 600 with an occlusion is shown. In this exemplary aerial image 600, an overpass with an upper road surface 620 and a lower road surface 610 are shown. The lower road surface 610 allows vehicle traffic to flow under the upper road surface 620. The upper road surface 620 allows vehicle traffic to cross over the lower road surface 610. The occlusion of the lower road surface 610 created by the upper road surface 620 is exemplary of the problem addressed by the exemplary method and apparatus.

In FIG. 7, an exemplary aerial image with an occlusion is shown overlaid with exemplary vehicle telemetry data. To address the occlusion problem, the exemplary method is configured to compare vehicle telemetry data with the aerial image 700. To illustrate, the aerial image 700 is shown with vehicle telemetry data 710, 720 overlaid on the aerial image 700. The darker telemetry data points 710 are illustrative of telemetry data received from vehicles traveling on the lower road surface 610 in a bottom to top direction while the lighter telemetry data points 720 are illustrative of vehicles travelling on the lower road surface 610 in a top to bottom direction. Cluster formations illustrate the separation between directions of travel and between the two lanes of travel of the lower road surface 610 of the underpass.

The determination of the dimensions and locations of the occluded road surface may first be performed by estimating a vehicle location in response to existing lower definition map data, such as publicly available road map data, the aerial image data, and the received vehicle telemetry data. The exemplary method may perform feature extraction via PCA in order to reduce the number of variables of the data set in order to simplify the data analysis. Multi-dimensional clustering may be accomplished by performing unsupervised learning to find clusters, or denser regions, of the cluster set. For example, Hierarchical Density-Based Spatial Clustering (HBDSCAN)® may be used. The overlapping clusters are then separated using elevation parameter to detect the occluded road surface. In response to the stacked roadways, other detection means, such as ground based mapping vehicles, are then requested to accurately perform a ground survey of the occlude roadway segments. The road topology may be an input to the map generation processor in order to detect the road features from the aerial imagery in order to generates a high definition map.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method comprising:
receiving a first image depicting a geographical area including a first roadway and an occluded area;
determining a location of the first roadway segment in response to the first image;
receiving a plurality of vehicle telemetry data associated with the first roadway segment and a second roadway segment within the occluded area;
updating a map data with the location of the first roadway;
determining a location of the occluded area in response to the first image and the plurality of vehicle telemetry data associated with the second roadway segment;
requesting an alternate data in response to determination of the location of the occluded area;
determining a location of a second roadway segment in response to the alternate data wherein the second roadway segment was occluded in the first image; and
updating the map data with the location of the second roadway segment.

2. The method of claim 1, wherein the first image is an aerial image depicting a top down view of the geographical area.

3. The method of claim 1, wherein the second roadway segment is a continuation of the first roadway segment.

4. The method of claim 1, wherein the alternate data is captured by a mapping vehicle travelling within the occluded area.

5. The method of claim 1, wherein the alternate data is a second image captured at a different time than the first image.

6. The method of claim 1, wherein the plurality of vehicle telemetry data includes a plurality of vehicle locations and directions of travel.

7. The method of claim 1, wherein the location of the first roadway segment is determined using image processing techniques on the first image.

8. The method of claim 1, wherein the location of the first roadway is determined in response to the first image and a principal component analysis of vehicle locations and directions of travel associated with the geographical area.

9. The method of claim 1, further operative for annotating the map data with a location of the occluded area in response to determining the location of the occluded area in response to the first image.

10. An apparatus for updating map data comprising:
a network interface to receive a first image, a plurality of vehicle telemetry data and an alternate data, the network interface further configured to transmit a request;
a memory configured to store the map data; and
a processor configured to determine a location of a first roadway segment in response to the first image and the plurality of vehicle telemetry data wherein the first image depicts a geographical area including the first roadway segment and an occluded area, update the map data with the location of the first roadway segment, determine a location of the occluded area in response to the first image and the plurality of vehicle telemetry data, generate the request and couple the request to the network interface wherein the request includes a command for the alternate data in response to determination of the location of the occluded area, determine a location of a second roadway segment in response to the alternate data wherein the second roadway segment is occluded in the first image and update the map data with the location of the second roadway.

11. The apparatus for updating a map data of claim 10, wherein the first image is an aerial image depicting a top down view of the geographical area.

12. The apparatus for updating a map data of claim 10, wherein the network interface is wireless network interface coupled to a cellular data network.

13. The apparatus for updating a map data of claim 10, wherein the alternate data is captured by a mapping vehicle travelling within the occluded area.

14. The apparatus for updating a map data of claim 10, wherein the alternate data is a second image captured at a different time than the first image.

15. The apparatus for updating a map data of claim 10, wherein the plurality of vehicle telemetry data includes a plurality of vehicle locations and directions of travel.

16. The apparatus for updating a map data of claim 10, wherein the location of the first roadway is determined using image processing techniques on the first image.

17. The apparatus for updating a map data of claim 10, wherein the location of the first roadway is determined in response to the first image and a principal component analysis of vehicle locations and directions of travel associated with the geographical area.

18. The apparatus for updating a map data of claim 10, wherein the processor is further configured to annotate the map data with the location of the occluded area in response to determining the location of the occluded area in response to the first image.

19. An apparatus comprising:
a memory configured to store map data;
a processor configured to receive a first image and a plurality of vehicle telemetry data, determine a location of a first roadway segment in response to the first image and the plurality of vehicle telemetry data, update the map data in response to the location of the first roadway segment, determine a location of an occluded area in response to the first image and the plurality of vehicle telemetry data, request an alternate data in response to determination of the location of the occluded area, determine a location of a second roadway in response to the alternate data wherein the second roadway is occluded in the first image, and update the map data with the location of the second roadway; and
a network interface for receiving the first image the alternate data and for transmitting the request for the alternate data via a data network.

20. The vehicle electronic control unit of claim 19, wherein the alternate data is a second image depicting the geographical area including the first roadway segment and the occluded area wherein the second image is captured from a different orientation than the first image.
